(19) United States
(12) Patent Application Publication
(10) Pub. No.: US 2005/0031780 A1
(43) Pub. Date: Feb. 10, 2005

(54) Method of forming a particle and apparatus therefor

(75) Inventor: Isao Matsui, Saitama-ken (JP)

Correspondence Address: FOLEY AND LARDNER;SUITE 500, 3000 K STREET NW, WASHINGTON, DC, 20007, US

(73) Assignee: KABUSHIKI KAISHA TOSHIBA

(21) Appl. No.: 10/873,624

(22) Filed: Jun. 23, 2004

(30) Foreign Application Priority Data
Jun. 24, 2003 (JP) 2003-178913

(51) Int. Cl. B05D 7/00

(52) U.S. Cl. 427/212; 427/226

(57) ABSTRACT

A method of forming a particle comprises the steps of: forming a droplet containing a first material; forming a core portion by heating the droplet to thermally decompose in a reaction vessel; and forming a shell portion which coats the core portion by heating a raw material gas containing a second material which differs from the first material to thermally decompose in the reaction vessel.

### CROSS-REFERENCE TO RELATED APPLICATIONS

This application is based upon and claims the benefit of priority from the prior Japanese Patent Application No. 2003-178913, filed on Jun. 24, 2003; the entire contents of which are incorporated herein by reference.

### BACKGROUND OF THE INVENTION

The present invention relates to a method of forming particles and an apparatus therefor, specifically to a method of forming particles and an apparatus therefor to form a dual-structure fine particle in gas phase.

Fine particles of nanometer size have drawn attention in recent years as a new type material owing to their novel characteristics such as large specific surface area (surface area per unit volume) and quantum size effect. Those kinds of nanometer-size fine particles may be applied to catalyst, electrode of battery, visible light LED (light emitting diode) element, and fluorescent substance for display depending on the kinds of fine particles.

For example, the electrode of a lithium ion battery is scudied to increase the capacity by applying silicon containing a large amount of lithium. That type of battery, however, has a problem of the destruction of structure during the repetition of charge-discharge cycles because of the repetition of volume changes of the electrode caused by entering and leaving lithium ions. To solve the problem, there is a proposal of the structure of a silicon particle of nanometer size coated by carbon. The performance improvement of the electrode is studied by applying a fine silicon particle laminated with a very fine particle thereon, or applying a particle having a core and shell structure prepared by laminating particles having different compositions from each other.

As an example of particle having that kind of laminated structure, there is a disclosure of the particle having a core made of crystalline silicon and a shell made of amorphous silicon coating the core at a thickness of from 1 to 2 nm (for example, C. R. Gorla et al., J. Vac. Sci. Technol., A15(3), May/Jun. 1997).

For forming that type of fine particle having laminated structure, however, it is not easy to form the core and the shell under good control to attain specified size of the core or thickness of the shell. Furthermore, there is a problem of not-easy in avoiding mixing the core and the shell at their interface and in forming the core and the shell establishing distinctive boundary therebetween.

### SUMMARY OF THE INVENTION

According to one aspect of the invention, there is provided a method of forming a particle having a core portion and a shell portion coating the core portion, comprising:

forming a droplet containing a first material;

forming the core portion by thermal decomposition of the droplet in a reaction vessel; and

forming the shell portion by thermal decomposition of a raw material gas containing a second material which differs from the first material in the reaction vessel.

According to another aspect of the invention, there is provided a method of forming a cluster of particles having a first particle located at a center and second particles surrounding the first particle, comprising:

forming a droplet containing a first material;

forming the first particle by thermal decomposition of the droplet in a reaction vessel; and

forming the second particles by thermal decomposition of a raw material gas containing a second material which differs from the first material in the reaction vessel.

According to another aspect of the invention, there is provided an apparatus for forming a particle comprising:

a reaction vessel;

a droplet forming section which forms a droplet to form a core portion consisting essentially of a first material;

a droplet feeding section which feeds the droplet formed in the droplet forming section to the reaction vessel; a gas feeding section which feeds a raw material gas to the reaction vessel, which raw material gas as the raw material of a shell portion consists essentially of a second material different from the first material; and

a heater for forming the core portion by the thermal decomposition of the droplet fed to the reaction vessel, and for forming the shell portion by the thermal decomposition of the raw material gas to coat the core portion.

### BRIEF DESCRIPTION OF THE DRAWINGS

The present invention will be understood more fully from the detailed description given herebelow and from the accompanying drawings of the embodiments of the invention. However, the drawings are not intended to imply limitation of the invention to a specific embodiment, but are for explanation and understanding only.

In the drawings:

FIG. 1 is a schematic drawing expressing the main part of the apparatus for forming a particle according to the first embodiment of the invention;

FIG. 2 is a conceptual drawing to explain the method of forming a droplet of TES using ultrasonic waves;

FIG. 3 is a conceptual drawing to explain the method of forming droplets by a spray nozzle;

FIG. 4 is a schematic cross sectional drawing expressing the structure of a particle;

FIG. 5 is a schematic cross sectional drawing expressing the structure of a particle;

FIG. 6 is a schematic diagram showing a transformation of the second example;

FIG. 7 is a schematic diagram showing a second transformation of the second example;

FIG. 8 is a schematic diagram showing a film structure including the clusters of the particles;

FIG. 9 is a schematic cross sectional drawing expressing the structure of a particle;

FIG. 10 is a schematic drawing for explaining the second embodiment of the invention; and

FIG. 11 is a schematic drawing of an apparatus for forming a particle, studied by the inventors of the prevent invention in the process to complete the invention.

### DETAILED DESCRIPTION

The embodiments of the invention will be described below referring to the drawings. First, the forming method which was investigated by the inventors of the present invention in the process to complete the invention will be described.

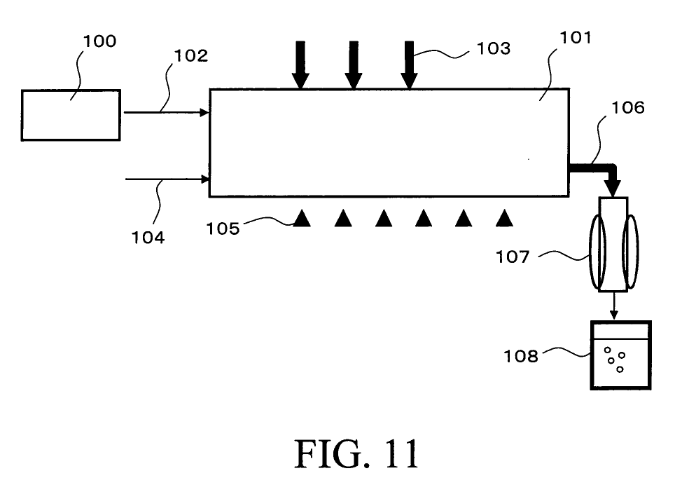

FIG. 11 is a schematic drawing of an apparatus for forming a particle, studied by the inventors of the prevent invention in the process to complete the invention. That is, the figure is a schematic drawing showing the main part of the apparatus to form a fine particle using a raw material gas.

The raw material silicon, as one of the raw materials, stored in a raw material tank 100 is gasified by nitrogen gas, and then is fed to a reaction vessel 101 via a feeding section 102. The inside of the reaction vessel 101 is filled with inert gas in advance by introducing, for example, nitrogen gas via a carrier gas feeding section 104. The reaction vessel 101 which has accepted the raw material silicon gas is heated to 600° C.-700° C. by a heater 105. The raw material gas receives thermal energy from the heater 105 to induce chemical reaction such as the one expressed by the following formula (1):
SiH₄→Si+2H₂ (1)

The raw material gas is decomposed to generate silicon (Si), and Si substances combine together to become a Si fine particle.

Then, methane (CH₄) as the second raw material is fed to the latter stage of the reaction vessel 101 from a gas feeding section 103. The CH₄ receives thermal energy from the heater 105 to induce chemical reaction such as the one expressed by the following formula (2):
CH₄→C+2H₂ (2)

Through the chemical reaction, the second raw material is decomposed in the reaction vessel 101 to generate a product (C). The product is deposited on the above-described Si fine particle to form a shell. Those reaction products are discharged from the reaction vessel 101 along with the inert gas and are fed to a cooler 107 to cool to near room temperature.

Thus cooled products are fed into a solution of surface active agent such as that of fatty acid salt to avoid coagulation of individual particles, and to mix them together. The solution of surface active agent is a liquid in which every molecule thereof contains both a hydrophilic group (compatible with water) and a lipophilic group (compatible with oil, also called the “hydrophobic group”).

After that, the fine particles mixed with the solution of the surface active agent are stored in a holding section 108 in the state of dissolving in the solution of surface active agent.

The formation of a dual-structure fine particle by the above-described method, however, has a problem of non-distinctive boundary between the core portion and the shell portion and of difficulty in accurate control of size of the core portion or of thickness of the shell portion because the core portion is formed in gas phase using a gas as the raw material in the former stage of the reaction vessel 101 and the shell portion is formed in gas phase using a gas as the raw material in the latter stage of the same reaction vessel 101.

To overcome the drawback, if the first reaction (the step of forming the core portion) is to be separated from the second reaction (the step for forming the shell portion), the reaction vessel has to have at least two independent stages, which raises a problem of a complex and large apparatus.

The present invention has been completed in order to solve the problems. The embodiments of the invention will be described in the following.

(First Embodiment of the Invention)

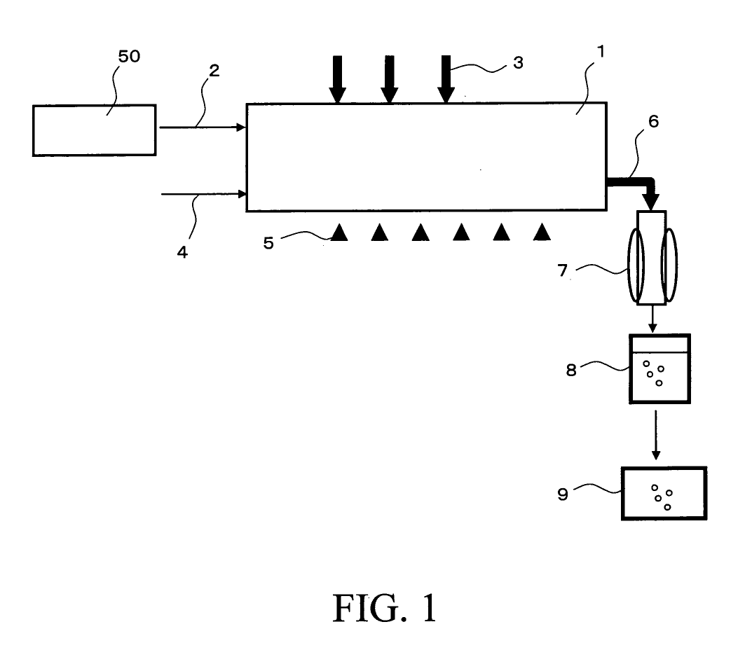

FIG. 1 is a schematic drawing expressing the main part of the apparatus for forming a particle according to the first embodiment of the invention. According to the first embodiment, the core portion of the dual-structure particle is formed using a droplet, while the shell portion thereof is formed by gas phase reaction using a raw material gas.

That is, the apparatus for forming a particle according to the first embodiment comprises: a reaction vessel 1; a droplet forming section 50; a droplet feeding section 2 which feeds the droplet formed in the droplet forming section 50 to the reaction vessel 1; a raw material gas feeding section 3 which feeds a raw material gas to the reaction vessel 1; an inert gas feeding section 4 which feeds an inert gas such as nitrogen as the carrier gas to the reaction vessel 1; a heater 5 as an exciter mounted to external wall of the reaction vessel 1; a discharging section 6 located opposite to the droplet feeding section 2; a cooler 7 which accepts the generated fine particle and the inert gas which are discharged from the reaction vessel 1 via the discharging section 6; a holding section 8 which holds the particle having passed the cooler 7; and a heater 9 which removes liquid components and surface-attached materials from the solvent containing particles stored in the holding section.

For instance, in the case of forming a dual-structure fine particle having a core portion made of silicon and a shell portion surrounding the core portion, a droplet tetra ethyl silane (TES) may be used as a silicon-containing raw material to form the core portion. As a raw material for forming the shell portion, methane (CH₄) may be used. The raw material of the core portion, the raw material of the shell portion, and the carrier gas are stored in their respective exclusive-use tanks (not shown) To form droplet TES in the droplet forming section 50, ultrasonic waves or a spray nozzle may be applied, for example.

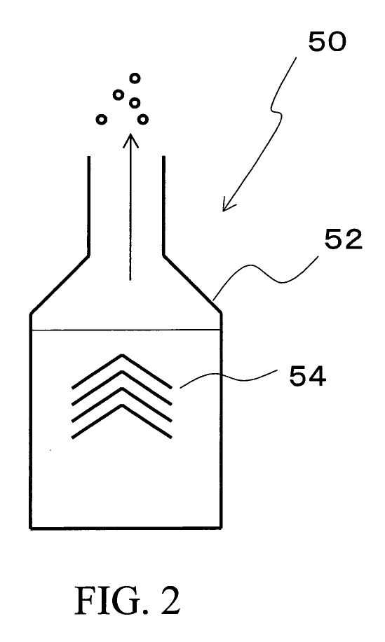

FIG. 2 is a conceptual drawing to explain the method of forming a droplet of TES using ultrasonic waves. A vessel 52 which holds TES diluted by alcohol or the like to an adequate concentration has a vibrator 54 which is vibrated by ultrasonic waves. Vibration of the vibrator 54 induces gasification of TES in the vessel 52 to form TES droplets. The size of formed droplets is adequately controlled by the dilution rate of TES, the size of vessel 52, the shape and position of vibrator 54, the frequency and power of ultrasonic waves, and the like.

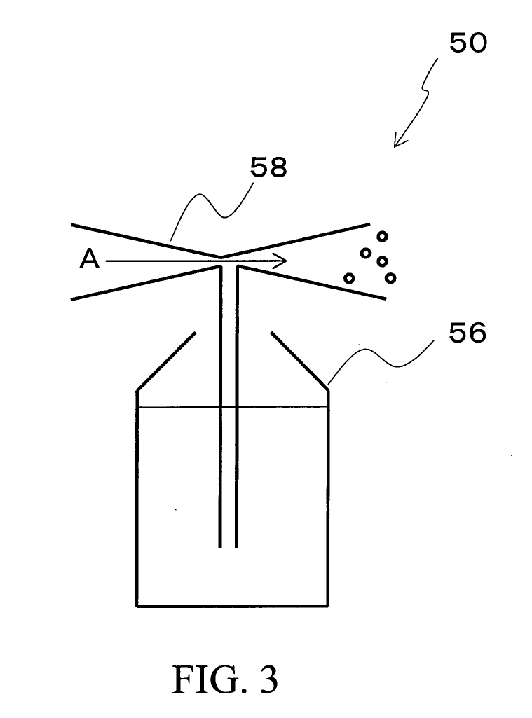

FIG. 3 is a conceptual drawing to explain the method of forming droplets by a spray nozzle. That is, a vessel 56 which holds TPS diluted by alcohol or the like to an adequate concentration is connected to a spray nozzle 58. When a specific carrier gas flows in the arrow direction at a specified velocity, the pressure-reducing effect of the throat of the nozzle 58 allows sucking TES from the vessel 56, which TES is then gasified to become droplets to be transferred by the carrier gas. Also in this case, the obtained size of droplet can be controlled by adequately adjusting the dilution rate of TES, the shape and size of the spray nozzle 58, the velocity of carrier gas, and the like.

Referring again to FIG. 1, the heater 5 is mounted on the external wall of the reaction vessel 1 to heat and hold the internal section of the reaction vessel to a specified temperature of enhancing a chemical reaction. Preferably the heater is mounted only onto the external wall around the center of the reaction vessel 1. It is partly because, if the chemical reaction occurs near the reactor-inlet of the droplet feeding section 2, the raw material gas feeding section 3, and the inert gas feeding section 4, the reaction products may adhere to the reactor-inlets of individual feeding sections to induce the clogging of the inlets, and partly because the once-formed particle is prevented from growth to an unnecessarily big. size.

The holding section 8 holds a solvent such as water, ethanol, and methanol, and the carrier gas is introduced to the holding section to blow into the solvent.

The following is the description of the method of forming a particle according to the first embodiment having the structure described above.
(1) First, an inert gas is fed to the reaction vessel 1 via the inert gas feeding section 4 to create a gas stream flowing from the reaction vessel 1 to. the discharging section 6, the cooler 7, the holding section 8, the heater 9, and a filter (not shown), successively.
(2) Then, the heater 5 heats the inside of the reaction vessel 1 to a temperature of from 600° C. to 700° C. By the heating, the atmosphere in the reaction vessel 1 is regulated to atmospheric pressure, or about 100 kPa. The temperature inside the cooler 7 is around room temperature, and the pressure therein is regulated to atmospheric pressure, or about 100 kPa.
(3) In the droplet forming section 50, droplets containing at least one kind of raw material silicon are formed, and these droplets are fed to the reaction vessel 1 via the droplet feeding section 2. Almost simultaneously with the droplet feeding, a gas which does not contain silicon is fed to the reaction vessel 1 via the gas feeding section 3.
(4) Within the reaction vessel 1, the chemical reactions (3) and (4), thermal decomposition reactions, occur. These chemical reactions occur in the zone heated to 600° C. to 700° C. by the heater 5, (hereinafter referred to as the “reaction zone”).

That is, the supplied TES droplet is heated in the reaction vessel 1, and the following decomposition reaction occurs in the droplet:
TES→Si(solid)+4C₂H₄(gas)+2H₂ (gas)(3)

Through the process, the Si particles are obtained. Their mean particle size corresponds to the droplet size, and is approximately 10 nm.

On the other hand, the raw material fed as gas generates carbon (C) following the reaction given below:
CH₄→C+2H₂ (4)

The generated carbon (C) deposits on the surface of the preliminarily formed Si particle.

Inside the reaction vessel 1, the carrier gas flow transfers the raw material gas and the products such as the Si particles coated by C on the surfaces thereof and C₂H₄ from their respective feeding sections toward the discharging section 6. Along with the flow of carrier gas, the Si particles coated by the generated C on the surface thereof flow to the discharging section 6, and leave the reaction vessel
(5) The temperature of carrier gas containing Si particles coated by C on the surface thereof, discharged from the reaction vessel 1, is a several hundred Celsius degrees, and the carrier gas is introduced to the cooler 7 to cool approximately to a room temperature.
(6) The cooled carrier gas containing the particles is introduced into a solvent stored in the holding section 8. While passing through the solvent, the Si particles coated by C on the surface thereof dissolve in the solvent, and only the carrier gas is emitted to atmosphere outside the holding section 8.
(7) The Si (silicon) particles coated by C (carbon) on the surfaces thereof are stored in the state of dissolving in the solvent. To take out the Si particles coated by C on the surface thereof, a desired volume of the solvent is brought out from the holding section 8, which solvent is heated by the heater 9 to evaporate the solvent component, thus to deposit only the solute, or the Si particles coated by C on the surface thereof.

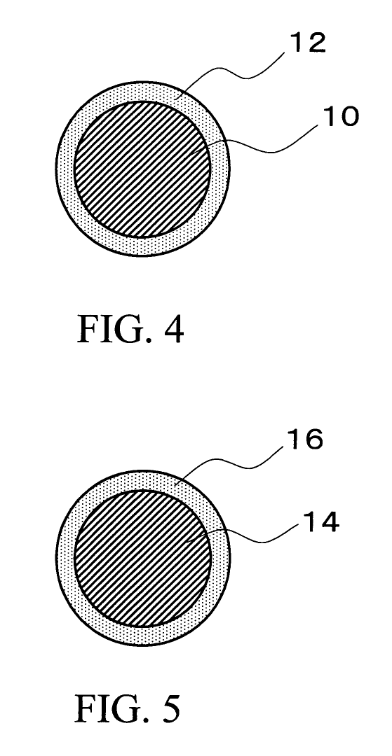

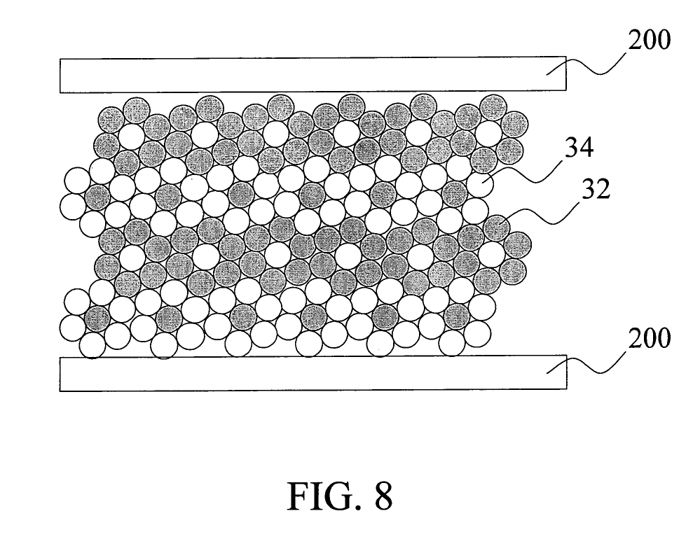

FIG. 4 is a schematic cross sectional drawing expressing the structure of thus formed particle. That is, the particle has a core portion 10 made of silicon and a shell portion 12 made of C positioned to coat the core portion. The core portion 10 and the shell portion 12 have a distinctive boundary 6 therebetween, and the size of the core portion 10 and the thickness of the shell portion 12 are accurately controlled to their respective specific ranges. To obtain that type of a dual-structure particle by the related art, the synthesis of the particle has to be conducted using at least two stages of reaction furnaces, as described before relating to FIG. 8. That is, when the core portion 10 and the shell portion 12 ace formed from their respective raw material gases, these raw material gases often mix with each other to form a zone having an intermediate composition of their respective gas compositions. To solve the problem, the core portion 10 and the shell portion 12 have to be formed in separate reaction vessels, respectively, which results in a complex and large apparatus.

In contrast, according to the first embodiment, the raw material for forming the core portion uses a droplet while the raw material for forming the shell portion uses a gas supply, thus the single-stage reaction vessel allows synthesizing the dual-structure particle having distinctively separated core portion and shell portion, which reduces the cost.

Thus deposited Si particle coated by C on the surface thereof can be used as, for example, the material for an electrode of a lithium battery.

The second example of the first embodiment is described below referring to FIG. 1 and FIG. 2. The second example synthesizes the core portion made of a chemical compound semiconductor, and coats the surface thereof with a semiconductor having a different composition therefrom.

For instance, when the core portion made of cadmium selenide (CdSe) as a chemical compound semiconductor is synthesized, the raw materials may be dimethyl cadmium (DMCd) and hydrogen selenide (H₂Se). To form the shell portion made of zinc sulfide (ZnS) to coat the core portion, the raw materials may be dimethyl zinc (DMZn) and hydrogen sulfide (H₂S) Those raw materials and carrier gas are stored in their respective exclusive-use tanks (not shown).

As described before, the heater 5 is preferably mounted only on the external wall around the center of the reaction vessel 1. The center-mounting of the heater is preferred to prevent the adhesion of reaction products near the reactor-inlets of individual feeding sections to induce the clogging of the inlets, and to prevent the growth of a once-formed particle to an unnecessarily big size.

The following is the description of the process for the second example.
(1) First, an inert gas is fed to the reaction vessel 1 via the inert gas feeding section 4 to create a gas stream flowing from the reaction vessel I to the discharging section 6, the cooler 7, the holding section 8, the heater 9, and the filter, successively.
(2) The heater 5 heats the inside of the reaction vessel 1 to a temperature of from 600° C. to 700° C. By the heating, the atmosphere in the reaction vessel 1 is regulated to atmospheric pressure, or about 100 kPa. The temperature inside the cooler 7 is regulated to around room temperature, and the pressure therein is regulated to about 100 kPa.
(3) In the droplet forming section 50, droplets containing dimethyl cadmium (DMCd) and hydrogen selenide (H₂Se) are formed, and these droplets are fed to the reaction vessel 1 via the feeding section 2. Almost simultaneously with the droplet feeding, vapors of DMZn (dimethyl zinc) and H₂S (hydrogen sulfide) are fed to the reaction vessel 1 via the gas feeding section 3.
(4) Within the reaction vessel 1, the chemical reactions (5) and (6), thermal decomposition reactions, occur. These chemical reactions occur in the zone heated to 600° C. to 700° C. by the heater 5, (hereinafter referred to as the “reaction zone”).

The supplied droplets are heated in the reaction furnace, and the following reaction occurs in the droplet:
DMCd+H₂Se→CdSe(solid)+2CH₄(gas) (5)

Through the reaction, the CdSe particles are obtained. Their mean particle size corresponds to the droplet size, and is approximately 10 nm.

On the other hand, the raw material fed as gas generates ZnS following the reaction given below:
DMZn+H₂S→ZnS+2CH₄ (6)

The generated ZnS deposits on the surface of the preliminarily formed CdSe particle.

Inside the reaction vessel 1, the carrier gas flow transfers the raw material gas and the products such as the CdSe particles coated by ZnS on the surfaces thereof and CH₄ from their respective feeding sections toward the discharging section 6.

Along with the flow of carrier gas, the CdSe particles coated by the generated ZnS on the surface thereof flow to the discharging section 6, and leave the reaction vessel 1.
(5) The temperature of carrier gas containing CdSe particles coated by ZnS on the surface thereof, discharged from the reaction vessel 1, is a several hundred Celsius degree, and the carrier gas is introduced to the cooler 7 to cool approximately to a room temperature.
(6) The cooled carrier gas containing the particles is introduced into a solvent stored in the holding section 8. While passing through the solvent, the CdSe particles coated by ZnS on the surface thereof dissolve in the solvent, and only the carrier gas is emitted to atmosphere outside the holding section 8.
(7) The CdSe particles coated by ZnS on the surfaces thereof are stored in the state of dissolving in the solvent. If the CdSe particles coated by ZnS on the surfaces thereof are wanted, a desired volume of the solvent is brought out from the holding section B. which solvent is heated by the heater 9 to evaporate the solvent component, thus to deposit only the solute, or the CdSe particles coated by ZnS on the surface thereof.

FIG. 5 is a schematic cross sectional drawing expressing the structure of the thus formed particle. That is, the particle has a core portion 14 made of CdSe and a shell portion 16 made of ZnS positioned to coat the core portion. The core portion 14 and the shell portion 16 have a distinctive boundary therebetween, and the size of the core portion 14 and the thickness of the shell portion 16 are accurately controlled to their respective specific ranges. To obtain that type of a dual-structure particle by the related art, the synthesis of the particle has to be conducted using at least two stages of reaction furnaces, as described before relating to FIG. S.

In contrast, according to the first embodiment, the raw material for forming the core portion uses a droplet while the raw material for forming the shell portion uses a gas supply, thus the single-stage reaction vessel allows synthesizing the dual-structure particle, which reduces the cost.

Thus deposited CdSe particle coated by ZnS on the surface thereof can be used as a material for light-emitting device or the like.

The third example of the first embodiment will be described below.

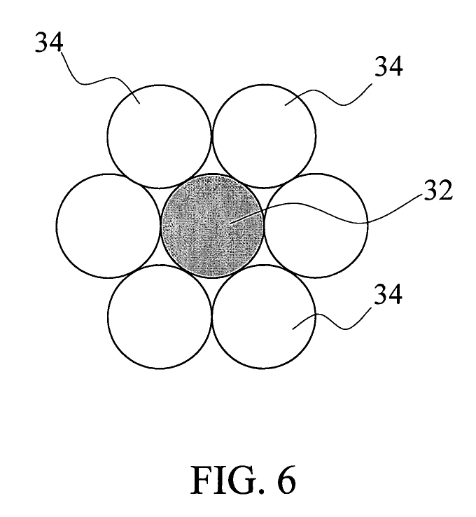

FIG. 6 is a schematic diagram showing a transformation of the second example. In the transformation, the semiconductor particle 32 is located at a center of the cluster and the conductive particles 34 are surrounding the semiconductor particle 32. The semiconductor particle 32 is made of semiconductor such as III-V compound and II-IV compound. For example, CdSe, ZnS or ZnSe may be used as the material of the semiconductor particle 32. The semiconductor particle 32 may have the core portion and the shell portion as described with reference to FIGS. 4 and 5.

The conductive particles 34 are made of electrically conductive material such as iron (Fe), platinum (Pt), silver (Ag), or copper (Cu), for example. These conductive particles 34 are surrounding the semiconductor particle 32 like satellites thereof.

This cluster structure can be formed by the following steps using the apparatuses shown in FIGS. 1 and 2:

First, in the droplet forming section 50, droplets containing dimethyl cadmium (DMCd) and hydrogen selenide (H₂Se) are formed. These droplets are fed to the reaction vessel I via the feeding section 2. Almost simultaneously with the droplet feeding, vapor of ferrocene (Fe(C₅H₅)₂) is fed to the reaction vessel 1 with hydrogen gas via the gas feeding section 3. The concentration of the vapor of ferrocene is controlled to be more than five times higher than that of DMCd.

Within the reaction vessel 1, thermal decomposition reactions occur. These chemical reactions occur in the reaction zone heated to 700° C. to 800° C. by the heater 5. The supplied droplets are heated in the reaction furnace, and the following reaction occurs in the droplet:
DMCd+H₂Se→CdSe(solid)+2CH₄(gas) (7)

Through the reaction, the CdSe particles are obtained. Their mean particle size corresponds to the droplet size, and is approximately 10 nm.

On the other hand, the raw material fed as gas generates a solid-phase Fe (iron) following the reaction given below:
Fe(C₅H₅)₂+H₂Fe(solid)+2C₅H₆(gas) (8)

The formed solid-phase Fe experiences the following chain reaction, and thus Fe particles are generated:
Fe+Fe→Fe₂ (9)
Fe₂+Fe→Fe₃ (10)
Fen+Fe→Fe particle (11)

These Fe particles precipitate on the surfaces of CdSe particles which have already been generated in the reaction vessel 1. As a result, the clusters of particles shown in FIG. 6 are obtained.

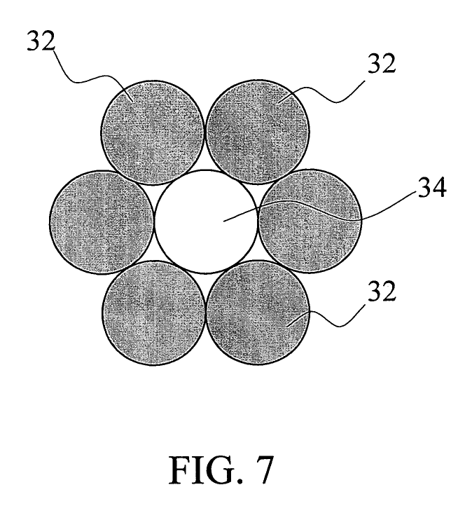

FIG. 7 is a schematic diagram showing a transformation of the third example. In the transformation, the conductive particle 34 located at a center of the cluster and the semiconductor particles 32 are surrounding the conductive particle 34. This cluster structure may be formed by the following steps:

First, in the droplet forming section 50, droplets containing ferrocene may be formed and fed to the reaction vessel 1 via the feeding section 2. Almost simultaneously with the droplet feeding, vapors of DMCd and H₂Se may be fed to the reaction vessel 1 via the gas feeding section 3. In this case, the concentrations of the vapors of DMCd and H₂Se are controlled to be more than five times higher than that of ferrocene.

Then, the Fe particles 34 are generated in the reaction zone within the reaction vessel 1 as explained with reference to the reactions (8) through (11) .

On the surfaces of these Fe particles, Cdse particles 32 precipitate as explained with the reaction (7). As a result, the clusters of particles shown in FIG. 7 are obtained.

FIG. 8 is a schematic diagram showing a film structure including the clusters of the particles. That is, the film structure has a pair of electrodes 200, and clusters of particles interposed therebetween. The clusters of particles include the clusters (first clusters) shown in FIG. 6 and the clusters (second clusters) shown in FIG. 7. The. numbers of the first and second clusters are almost the same. The first and the second clusters are almost uniformly distributed between the electrodes 200. Such a structure may be formed by mixing the same amount of the first and second clusters with an appropriate solvent (if necessary), and by coating or painting the mixed product on one of the electrodes 200.

In the film structure shown in FIG. 8, since each of the semiconductor particles 32 is surrounded by the conductive particles 34, electric current can be passed effectively through each semiconductor particle 32. That is, the electric current injected via the electrodes 200 can be effectively injected into the semiconductor particles 32 through the adjacent conductive particles 34. As a result, an intense light emission from these semiconductor particles 32 can be realized.

The fourth example of the first embodiment will be described below. The third example synthesizes the core portion made of an oxide semiconductor, and coats the surface thereof with a semiconductor having a different composition therefrom.

For the case of synthesizing TiO₂ as an example of oxide semiconductor, titanium tetra-isopropoxide (TTIP) may be used as the raw material. When Nb₂O₅ is used as the semiconductor for coating, the raw material thereof may be penta-ethoxy niobium (Nb (OC₂H₅)₅)

The main part of the manufacturing method will be described below referring to FIG. 1 and FIG. 2.
(1) An inert gas is fed to the reaction vessel 1 via the inert gas feeding section 4 to create a gas stream flowing from the reaction vessel I to the discharging section 6, the cooler 7, the holding section 8, the heater 9, and the filter, successively.
(2) The heater 5 heats the inside of the reaction vessel I to a temperature of from 600° C. to 700° C. By the heating, the atmosphere in the reaction vessel 1 is regulated to about 100 kPa. The temperature inside the cooler 7 is regulated to around room temperature, and the pressure therein is regulated to about 100 kPa.
(3) In the droplet forming section 50, droplets containing TTIP are formed, and these droplets are fed to the reaction vessel 1 via the feeding section 2. Almost simultaneously with the droplet feeding, vapor of Nb(OC₂H₅)₅ is fed to the reaction vessel 1 via the gas feeding section 3.
(4) Within the reaction vessel 1, the chemical reactions (12) and (13), thermal decomposition reactions, occur. These chemical reactions occur in the zone heated to 600° C. to 700° C. by the heater 5, (hereinafter referred to as the “reaction zone”).

The supplied droplets are heated in the reaction furnace, and the following reaction occurs in the droplet:
TTIP→TiO₂(solid)+4C₂H₆(gas)+2H₂O (12)

Through the reaction, the TiO₂ particles are obtained. Their mean particle size corresponds to the droplet size, and is approximately 10 nm.

On the other hand, the raw material fed as gas generates Nb₂O₅ following the reaction given below:
2Nb(OC₂H₅)₅→Nb₂O₅+10C₂H₄+5H₂O (13)

The generated Nb₂O₅ deposits on the surface of the preliminarily formed TiO₂ particle.

Inside the reaction vessel 1, the carrier gas flow transfers the raw material gas and the products such as the TiO₂ particles coated by Nb₂O₅ on the surfaces thereof and C₂H₆ from their respective feeding sections toward the discharging section 6.

Along with the flow of carrier gas, the produced TiO₂ particles coated by the generated Nb₂O₅ on the surfaces thereof flow to the discharging section 6, and leave the reaction vessel 1.
(5) The temperature of carrier gas containing TiO₂ particles coated by Nb₂O₅ on the surface thereof, discharged from the reaction vessel 1, is a several hundred Celsius degree, and the carrier gas is introduced to the cooler 7 to cool approximately to a room temperature.
(6) The cooled carrier gas containing the particles is introduced into a solvent stored in the holding section 8. While passing through the solvent, the TiO₂ particles coated by Nb₂O₅ on the surfaces thereof dissolve in the solvent, and only the carrier gas is emitted to atmosphere outside the holding section 8.
(7) The TiO₂ particles coated by Nb₂O₅on the surfaces thereof are stored in the state of dissolving in the solvent. If the TiO₂ particles coated by Nb₂O₅ on the surfaces thereof are wanted, a desired volume of the solvent is brought out from. the holding section 8, which solvent is heated by the heater 9 to evaporate the solvent component, thus to deposit only the solute, or the TiO₂ particles coated by Nb₂O₅ on the surfaces thereof.

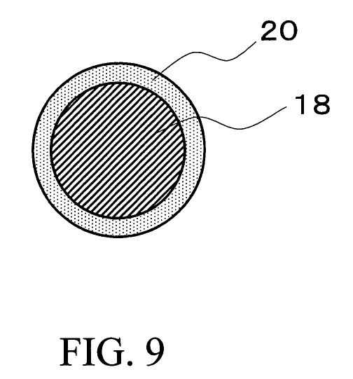

FIG. 9 is a schematic cross sectional drawing expressing the structure of the thus formed particle. That is, the particle has a core portion 18 made of TiO₂ and a shell portion 20 made of Nb₂O₅ positioned to coat the core portion. The core portion 18 and the shell portion 20 have a distinctive boundary therebetween, and the size of the core portion 18 and the thickness of the shell portion 20 are accurately controlled to their respective specific ranges. To obtain that type of a dual-structure particle by the related art, the synthesis of the particle has to be conducted using at least two stages of reaction furnaces, as described before relating to FIG. 8.

In contrast, according to the first embodiment, the raw material for forming the core portion uses droplets while the raw material for forming the shell portion uses a gas supply, thus the single-stage reaction vessel allows synthesizing the dual-structure particle, which reduces the cost.

Thus deposited TiO₂ particle coated by Nb₂O₅ on the surface thereof can be used as, for example, a material for a solar cell.

(Second Embodiment of the Invention)

The second embodiment of the invention will be described in the following.

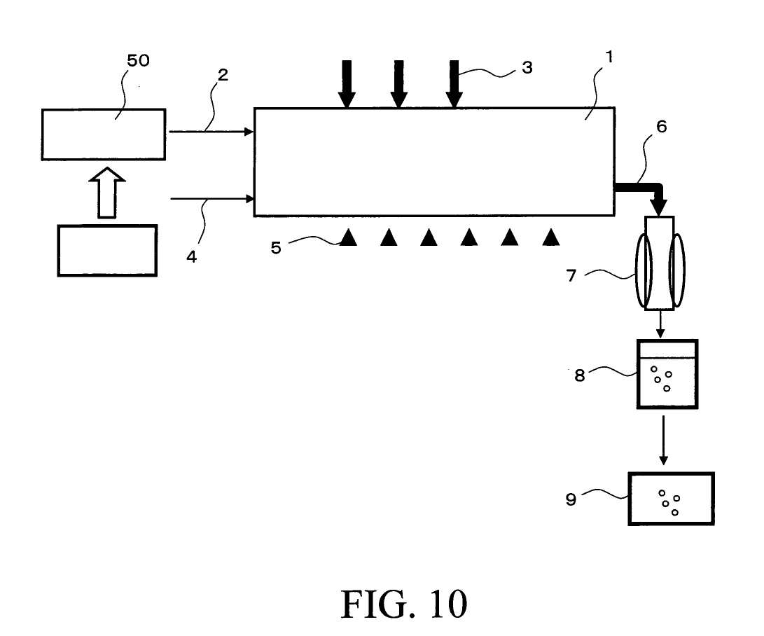

FIG. 10 is a schematic drawing for explaining the second embodiment of the invention. For the same section as described before relating to FIG. 1, the same reference number is given without giving detail description.

One of the characteristics of the second embodiment is to introduce a reducing agent for reducing the raw material into a droplet followed by feeding to the reaction vessel 1.

The following is the description of the method of the second embodiment:
(1) First, an inert gas is fed to the reaction vessel 1 via the gas feeding section 4 to create a gas stream flowing from the reaction vessel 1 to the discharging section 6, the cooler 7, the holding section 8, the heater 9, and the filter, successively.
(2) The heater 5 heats the inside of the reaction vessel 1 to a temperature of from 200° C. to 400° C. By the heating, the atmosphere in the reaction vessel 1 is regulated to about 100 kPa. The temperature inside the cooler 7 is regulated to around room temperature, and the pressure therein is regulated to about 100 kPa.
(3) In the droplet forming section 50, droplets containing at least one kind of raw material and a reducing agent are formed, and these droplets are fed to the reaction vessel 1 via the feeding section 2. Almost simultaneously with the droplet feeding, a gas is fed to the reaction vessel 1 via the gas feeding section 3. Furthermore, almost simultaneously with the droplet feeding, H₂O as a gas to reduce the raw material is fed to the reaction vessel 1 via the feeding section 4.
(4) Within the reaction vessel 1, the chemical reaction expressed by the formula (14), a reduction reaction, occurs by the action of NaBH₄ as the reducing agent. The chemical reaction occurs in the zone heated to 200° C. to 400° C., which temperature range is lower than that of above-described reaction formulae (3) and (4).
   TES+NaBH₄→S1+C₂H₆+2H₂+Na+B (14)

Through the reaction, the Si particles are obtained. Their mean particle size corresponds to the droplet size, and is approximately 10 nm.

On the other hand, the raw material fed as gas generates carbon (C) following the reaction given below to deposit on the surface of the preliminarily formed Si particle:
CH₄C+2H₂ (15)

Inside the reaction vessel 1, the carrier gas flow transfers the raw material gas and the products such as the Si particles coated by C on the surfaces thereof and C₂H₆ from their respective feeding sections toward the discharging section 6.

Since succeeding steps are the same as those described before, further description is not given here.

As described above, the second embodiment allows the reactions to occur at a low temperature because the reduction reaction is utilized to form the core portion. As a result, the core portion can be formed in advance at a lower temperature than that for forming the shell portion, thus the core portion and the shell portion can be formed in further distinctively. separated state.. That is, the second embodiment allows forming a dual-structure particle having further distinctive boundary between the core portion and the shell portion,

In addition, particle formation at a low temperature can improve the use efficiency of thermal energy.

According to the embodiments of the invention, described above, the use of a droplet as a raw material for forming a core portion and the feed of gas as a raw material for forming a shell portion allow synthesizing a dual-structure particle having distinctively separately a core portion and a shell portion therein by single-stage reaction vessel, which reduces the cost. The particle thus coated by deposited C on the surface thereof can be used as, for example, the material of an electrode of a lithium battery, providing significant industrial merits.

The above description has explained the embodiments of the invention referring to the examples. However, the present invention is not limited to these examples.

For example, the exciter to excite the raw material gas may be a means other than the heater, such as a discharger and a light-emitter. For instance, an ultraviolet lamp is installed inside or outside the reaction vessel, and the lamp irradiates ultraviolet rays to the raw material to excite for the chemical reactions.

Also for the method of forming a droplet, any method which is selected by a person skilled in the art from known technology is within the scope of the present invention.

In addition, all kinds of the methods for forming a particle and the apparatuses for forming a particle which are applicable through modifications in design given by the person skilled in the art on the basis of the method of forming a particle and the apparatus for forming a particle described above in the embodiments of the invention are also included in the scope of the present invention.

1. A method of forming a particle having a core portion and a shell portion coating the core portion, comprising:
forming a droplet containing a first material;
forming the core portion by thermal decomposition of the droplet in a reaction vessel; and
forming the shell portion by thermal decomposition of a raw material gas containing a second material which differs from the first material in the reaction vessel.

2. The method of forming a particle according to claim 1, wherein the forming the core portion includes decomposing the droplet into the core portion of a solid phase and a gas.

3. The method of forming a particle according to claim 1, wherein the core portion is substantially spherical.

4. The method of forming a particle according to claim 1, wherein a stream of carrier gas flowing from an end of the reaction vessel to other end thereof is formed, and the droplet is fed to the reactor vessel by introducing the droplet to the carrier gas at the upper stream side than the introducing point of the raw material gas thereinto.

5. The method of forming a particle according to claim 1, wherein the temperature at which the thermal decomposition of the droplet is performed is lower than the temperature at which the thermal decomposition of the raw material gas is performed.

6. The method of forming a particle according to claim 5, wherein a reducing agent for decreasing the temperature at which the thermal decomposition of the droplet is performed is added to the droplet.

7. A method of forming a cluster of particles having a first particle located at a center and second particles surrounding the first particle, comprising:
forming a droplet containing a first material;
forming the first particle by thermal decomposition of the droplet in a reaction vessel; and
forming the second particles by thermal decomposition of a raw material gas containing a second material which differs from the first material in the reaction vessel.

8. The method of forming a cluster of particles according to claim 7, wherein the forming the first particle includes decomposing the droplet into the first particle of a solid phase and a gas.

9. The method of forming a cluster of particles according to claim 7, wherein the first particle is substantially spherical.

10. The method of forming a cluster of particles according to claim 7, wherein a stream of carrier gas flowing from an end of the reaction vessel to other end thereof is formed, and the droplet is fed to the reactor vessel by introducing the droplet to the carrier gas at the upper stream side than the introducing point of the raw material gas thereinto.

11. The method of forming a cluster of particles according to claim 7, wherein the temperature at which the thermal decomposition of the droplet is performed is lower than the temperature at which the thermal decomposition of the raw material gas is performed.

12. The method of forming a cluster of particles according to claim 11, wherein a reducing agent for decreasing the temperature at which the thermal decomposition of the droplet is performed is added to the droplet.

13. The method of forming a cluster of particles according to claim 7, wherein a concentration of the raw material gas containing the second material in the reaction vessel is higher than 5 times of a concentration of the droplet containing the first material in the reaction vessel.

14. The method of forming a cluster of particles according to claim 7, wherein the first particle is made of a semiconductor and the second particles are made of a conductive material.

15. The method of forming a cluster of particles according to claim 7, wherein the first particle is made of a conductive material and the second particles are made of a semiconductor.

16. An apparatus for forming a particle comprising:
a reaction vessel;
a droplet forming section which forms a droplet to form a core portion consisting essentially of a first material;
a droplet feeding section which feeds the droplet formed in the droplet forming section to the reaction vessel;
a gas feeding section which feeds a raw material gas to the reaction vessel, which raw material gas as the raw material of a shell portion consists essentially of a second material different from the first material; and
a heater for forming the core portion by the thermal decomposition of the droplet fed to the reaction vessel, and for forming the shell portion by the thermal decomposition of the raw material gas to coat the core portion.

17. The apparatus for forming a particle according to claim 16, wherein the droplet forming section includes a vessel which holds a liquid, and a vibrator which vibrates the liquid held in the vessel.

18. The apparatus for forming a particle according to claim 16, wherein the droplet forming section includes a vessel which holds a liquid, a spray nozzle, and a tube which introduces the liquid to a throat of the spray nozzle.

19. The apparatus for forming a particle according to claim 16, wherein the heater is provided only a center part of the reaction vessel.

20. The apparatus for forming a particle according to claim 16, further comprising a cooler which cools the particle discharged from the reaction vessel, and a holding section which holds the particle having passed the cooler.
